(19) United States
(12) Patent Application Publication
(10) Pub. No.: US 2018/0261112 A1
(43) Pub. Date: Sep. 13, 2018

(54) SYSTEM AND METHOD FOR AUTOMATED HANDOFF BETWEEN UNMANNED AERIAL VEHICLES AND AUTONOMOUS GROUND VEHICLES

(71) Applicant: Walmart Apollo, LLC, Bentonville, AR (US)

(72) Inventor: John J. O'Brien, Farmington, AR (US)

(73) Assignee: Walmart Apollo, LLC, Bentonville, AR (US)

(21) Appl. No.: 15/917,995

(22) Filed: Mar. 12, 2018

Related U.S. Application Data
(60) Provisional application No. 62/470,032, filed on Mar. 10, 2017.

(51) Int. Cl. G08G 7/00; G05D 1/10; G05D 1/00; B64C 39/02; B64D 1/08; H04W 12/06; H04L 9/30

(52) U.S. Cl. CPC G08G 7/00; G05D 1/101; G05D 1/0094; B64C 39/024; B64D 1/08; B64C 2201/146; H04L 9/30; B64C 2201/128; B64C 2201/108; B64C 2201/027; B64C 2201/141; H04W 12/06

(57) ABSTRACT

A system and method for facilitating a package exchange between a AGV and an UAV is disclosed, wherein the system and method includes authenticating the package exchange between the AGV and the UAV, wherein the AGV and the UAV each transmit authentication information to each other; determining a first set of positioning information, wherein the AGV utilizes mission information and information obtained from one or more sensors; determining a second set of positioning information, wherein the UAV utilizes mission information and information obtained from one or more sensors; transmitting the first set of positioning information from the AGV to the UAV; transmitting the second set of positioning information from the UAV to the AGV; exchanging the package between the AGV and the UAV in response to the transmitted first and second sets of positioning information; and transmitting a confirmation signal to a central server.

### BACKGROUND

### 1. Technical Field

The present disclosure relates to unmanned aerial vehicles or drones and more specifically to the utilization of those vehicles for package delivery and package handoff with an autonomous ground vehicle.

### 2. Introduction

Aerial vehicles such as unmanned aerial vehicles (UAVs) can be used for performing surveillance, reconnaissance, and exploration tasks for military and civilian applications. Such aerial vehicles may carry a payload configured to perform a specific function. In particular, the use of UAVs or drones for package delivery has become more prevalent. UAVs are generally aerial vehicles that operate without a human pilot aboard. UAVs may be utilized to delivery consumer goods, commercial goods, emergency aid, and repair or maintenance services. These UAVs may include multi-propeller helicopters, airplanes, or any other configuration for aerial flight. A UAV may be any size, but are generally used for taking off and landing in small spaces, and thus generally range from a few inches in length to several feet. UAVs that are utilized for package delivery are generally structured to support weights of less than an ounce to fifty pounds.

Autonomous ground vehicles (AGVs) may be utilized in conjunction with UAVs in a package delivery system, wherein the AGV may move, without a human driver aboard, throughout a geographic area in order to interact with a UAV. AGVs may include a storage area for storing items delivered by the UAV.

To facilitate the delivery of a large number of packages, a UAV package delivery system maybe include a central server that generates drone routing configurations. The central server may be located anywhere, as it communicates with the system via remote means. For instance, a central server may route a UAV to an AGV, so that the AGV may deliver a package to a consumer or commercial site on the ground. In these instances, there exists a need for a system and method for facilitating a handoff from a UAV to an AGV.

### SUMMARY

A system and method for facilitating a package exchange between a AGV and an UAV is disclosed, wherein the method includes authenticating the package exchange between the AGV and the UAV, wherein the AGV and the UAV each transmit authentication information to each other; determining a first set of positioning information, wherein the AGV utilizes mission information and information obtained from one or more sensors; determining a second set of positioning information, wherein the UAV utilizes mission information and information obtained from one or more sensors; transmitting the first set of positioning information from the AGV to the UAV; transmitting the second set of positioning information from the UAV to the AGV; exchanging the package between the AGV and the UAV in response to the transmitted first and second sets of positioning information; and transmitting a confirmation signal to a central server.

A system for facilitating a package exchange between an AGV and UAV is disclosed, wherein the system includes a central station comprising at least one computer processor capable of determining a pairing between a UAV and a AGV; wherein the UAV comprises at least one computer processor capable of determining a first set of positioning information based on mission information and information obtained from one or more sensors, transmission means for transmitting the first set of positioning information to the AGV, and a package grasping member capable of grasping and maneuvering the package; wherein the AGV comprises at least one computer processor capable of determining a second set of positioning information based on mission information and information obtained from one of more sensors, transmission means for transmitting the second set of positioning information to the UAV, and a receptacle for storing the package.

A method for facilitating a package exchange between an AGV and UAV is disclosed, wherein the method includes determining, via a central station, a UAV and AGV pairing based on at least one of mission information, location information regarding the UAV and AGV, and operation information regarding the UAV and AGV; authenticating the package exchange between the AGV and the UAV, without the AGV and the UAV each transmit authentication information to each other; determining a meeting point location based on at least one of speed, direction, and altitude of the UAV and AGV; determining a first set of positioning information, wherein the AGV utilizes mission information and information obtained from one or more sensors; determining a second set of positioning information, wherein the UAV utilizes mission information and information obtained from one or more sensors; transmitting the first set of positioning information from the AGV to the UAV; transmitting the second set of positioning information from the UAV to the AGV; determining whether exchanging the package is viable based on the mission information and the information obtained from one or more sensors; transmitting a signal indicating that exchanging the package is not viable if exchanging the package is not viable; one of placing the package within a receptacle in the AGV or removing the package form within a receptacle in the AGV; and transmitting a confirmation signal to the central station.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems and methods for package delivery and package handoff between an unmanned aerial vehicle and an autonomous ground vehicle.

### BRIEF DESCRIPTION OF THE DRAWINGS

FIG. 1 illustrates an example implementation of the system for automated handoff between unmanned aerial vehicles and autonomous ground vehicles;

FIG. 2 illustrates an example unmanned aerial vehicle component of the system;

FIG. 3 illustrates an example autonomous ground vehicle component of the system;

FIG. 4 illustrates an example autonomous ground vehicle component of the system;

FIG. 5 illustrates an example autonomous ground vehicle component of the system;

FIG. 6 illustrates an example autonomous ground vehicle component of the system;

FIG. 7 illustrates an example autonomous ground vehicle component of the system;

FIG. 8 illustrates an example autonomous ground vehicle component of the system; and

FIG. 9 illustrates an exemplary implementation of the method for automated handoff between unmanned aerial vehicles and autonomous ground vehicles.

### DETAILED DESCRIPTION

A system and method are disclosed which facilitate package delivery and package handoff between an unmanned aerial vehicle (UAV) and an autonomous ground vehicle (AGV).

Various embodiments of the disclosure are described in detail below. While specific implementations are described, it should be understood that this is done for illustration purposes only. Other components and configurations may be used without parting from the spirit and scope of the disclosure.

The systems, devices, and methods of the present invention provide interaction between a UAV and an AGV. Description of the UAV may be applied to any other type of unmanned vehicle, or any other type of movable object. The interaction between the UAV and the AGV may include a package handoff between the UAV and the AGV.

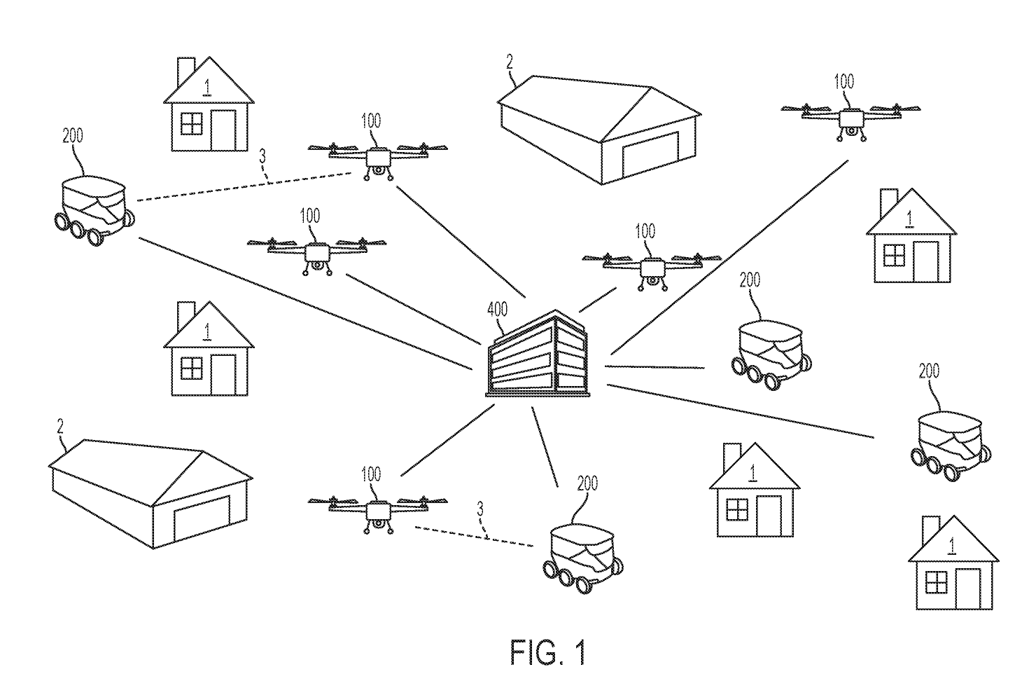

FIG. 1 shows an exemplary configuration of a package delivery system. One or more UAVs 100 may be configured to transport packages from a central station 400 to a delivery site 1, or from a central station 400 to an AGV 200, from an AGV 200 to a central station 400, from an AGV 200 to a delivery site 1, from a pickup site 2 to a central station 400, and/or from a pickup site 2 to an AGV 200. In an exemplary configuration, a central station 400 may coordinate the delivery of packages, utilizing UAVs 100 to transport packages to and from AGVs 200, so that packages may be efficiently delivered from a pickup site 2 to a delivery site 1. For example the central station 400 may pair a particular UAV 100 with an AGV 200 to coordinate a package handoff. Once the pairing is established, the paired UAV 100 and AGV 200 may communicate with each other via a direct communication 3.

The UAV 100 may be an aerial vehicle. The UAV 100 may be of any size; for instance, a UAV may be 10 cm at its greatest diameter, or 1 meter at its greatest diameter. The UAV 100 may be capable of receiving a payload or package 300 that is of significant weight; for instance, a UAV may receive a package 300 that is from less than an ounce to fifty pounds.

The UAV 100 may have one or more propulsion units that may permit the UAV to move about in the air. The UAV 100 may be a rotorcraft. In some instances, the UAV may be a multi-rotor craft that may include a plurality of rotors. The plurality or rotors may be capable of rotating to generate lift for the UAV 100. The rotors may be propulsion units that may enable the UAV to move about freely through the air. The rotors may rotate at the same rate and/or may generate the same amount of lift or thrust. The rotors may optionally rotate at varying rates, which may generate different amounts of lift or thrust and/or permit the UAV to rotate.

The UAV 100 may be capable of taking off and landing from various platforms, including a central location, a package distribution station, a restocking station, a manned vehicle, or an AGV 200. The UAV 100 may be capable of obstacle avoidance by detecting and avoiding obstacles while taking off, landing, navigating in flight, and/or facilitating a handoff with an AGV 200. The UAV 100 may be manually controlled by a remote user, or may operate in autonomous or semi-autonomous flight mode. The user may be able to toggle between different flight modes, or different flight modes may kick in for different situations.

Similarly, the AGV 200 may have one or more propulsion units that may permit the vehicle to move about. The AGV 200 may be capable of moving over land, over uneven terrain, or on the water's surface. The one or more propulsion units may enable the AGV to move about one or more, two or more, three or more, four or more, five or more, six or more degrees of freedom. The propulsion units may include wheels that may permit the AGV 200 to move over land. Other examples of propulsion units may include, but are not limited to treads, propellers, rotors, or jets. The propulsion units may enable the AGV 200 to move over a single type or multiple types of terrain. The propulsion units may permit the AGV 200 to move up inclines or down slopes. The AGV 200 may be self-propelled. The AGV 200 may have an engine, battery, or any type of driver. An AGV 200 may have an internal combustion engine, or may run on a fuel and/or on electricity.

The AGV 200 may also be capable of traversing land via installed tracks or rails. The AGV 200 may be capable of obstacle avoidance by detecting and avoiding obstacles while traversing a geographic area and/or facilitating a handoff with an UAV 100. The AGV 200 may be manually controlled by a remote user, or may operate in autonomous or semi-autonomous mode.

Communications may be provided between the UAV 100 and the AGV 200. Such communications may include cellular, radiofrequency, near field communication, infrared, Bluetooth, Wi-Fi, satellite, or any other means for communication. Control commands and data may be sent from the UAV 100 to the AGV 200, and also from the AGV 200 to the UAV 100.

The package delivery system may also include a central station 400 which may coordinate package delivery by one or more UAVs 100 and AGVs 200. The central station 400 may include a computing system 401, a receiver 410, and a transmitter 411. Computing system 401 may be utilized to determine routing and handoff information for the package delivery system. The receiver 410 and transmitter 411 may utilize cellular, radiofrequency, near field communication, Bluetooth, Wi-Fi, or any other means for communication.

The central station 400 may utilize a receiver 410 to receive information from a delivery service, or from UAVs 100 and AGVs 200. For instance, the central station 400 may receive location information from the UAVs 100 and AGVs 200 via a Global Positioning System (GPS), local positioning, mobile phone tracking, or other means. The central station 400 may also receive package delivery information from a delivery service, including mission details like a package destination, package origination location, package weight, and special instructions for handling of the package. The central station 400 may utilize the transmitter 411 to transmit information to a delivery service, or to UAVs 100 and AGVs 200. For instance, the central station 400 may transmit received package information to one or more UAVs 100 or AGVs 200. Based on the received mission information and the location information for UAVs and 100 and AGVs 200, the central station 400 may also identify a pair of UAV 100 and AGV 200 for handoff of a package between the particular UAV 100 and the particular AGV 200. The central station 400 may also provide route information to the UAV 200 or AGV 200.

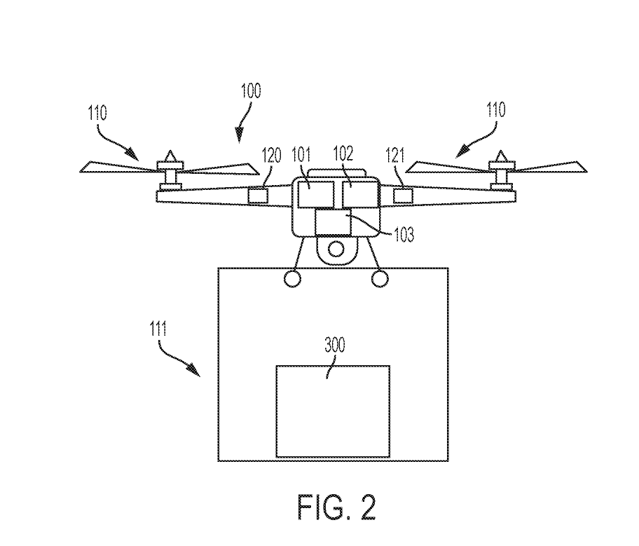

FIG. 2 shows an example of an UAV 100 that may be associated with a package delivery system. In an embodiment of the invention, the UAV 100 includes one or more propulsion elements 110, as well as a receptacle 111 for a package 300. The UAV 100 includes a receiver 101 and transmitter 102, which allow the UAV to communicate with central station 400 and AGV 200. Receiver 101 and transmitter 102 may utilize cellular, radiofrequency, near field communication, infrared, Bluetooth, Wi-Fi, satellite, or any other means for communication. The UAV 100 may also include a computing device 103, which may determining positioning information for the paired UAV 100 and AGV 200, as well as authentication information for the paired UAV 100 and AGV 200. The UAV 100 also includes one or more visual sensors 120 and proximity sensors 121. Visual sensors 120 may include one or more video cameras and/or infrared cameras. Proximity sensors 121 may include one or more RADAR sensors, LIDAR sensors, or infrared sensors. These visual sensors 120 and proximity sensors 121 may be placed on one or more surfaces of the UAV 100. The visual sensors 120 and proximity sensors 121 allow for the UAV 100 to determine maneuvers when facilitating a handoff with an AGV 200.

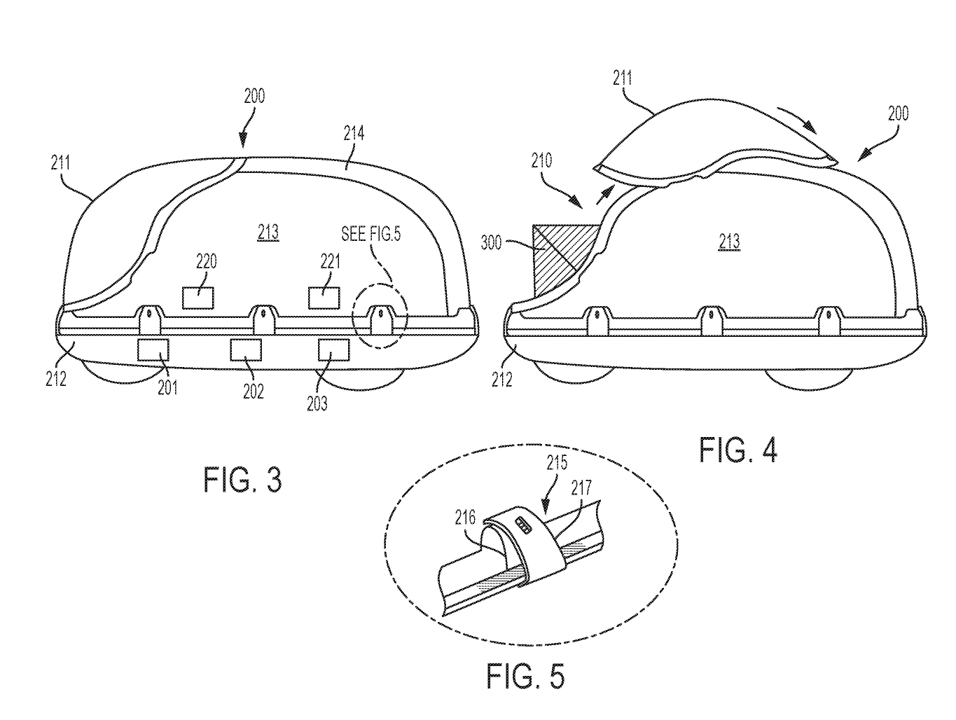

As shown in FIG. 3, the AGV 200 may include a body 213 that may be dome-shaped, and a base portion 212 that may be generally flat. The body 213 may include a track 214 to allow a retractable hood 211 to slide back along the body 213. The AGV 200 may also include clamps 215 which engage the body 213 and base portion 212 of the AGV such that they are removably attached together. In this manner, the body 213 and base portion 212 may form a cavernous area that forms a receptacle 210 for a package 300. The base portion may include a flat bottom or wheels to allow the AGV to be stationary or mobile.

The AGV 200 includes a receiver 201 and transmitter 202, which allow the UAV to communicate with central station 400 and UAV 100. Receiver 201 and transmitter 202 may utilize cellular, radiofrequency, near field communication, Bluetooth, Wi-Fi, or any other means for communication. The AGV 200 may also include a computing device 203, which may determine positioning information for the paired UAV 100 and AGV 200, as well as authentication information for the paired UAV 100 and AGV 200. The AGV 200 also includes one or more visual sensors 220 and proximity sensors 221. Visual sensors 220 may include one or more video cameras and/or infrared cameras. Proximity sensors 221 may include one or more RADAR sensors, LIDAR sensors, or infrared sensors. The sensors 220 and 221 are shown in FIG. 4 as being attached to the body 213, and receiver 201, transmitter 202, and computing device 203 attached to the base portion 212. However, it is understood by those in the art that these components may be located anywhere on the AGV 200.

As shown in FIG. 4, the AGV 200 may include a receptacle 210 having a basin capable of receiving a package 300 from an UAV 100. The receptacle 210 may include a retractable hood 211 that is capable of retracting to provide an access point for the UAV 100 and the package 300. When the hood 211 is not retracted, it covers the receptacle 210 and any items located within the receptacle 210, thus hiding the items from view, and protecting them from weather. The AGV 200 may also include refrigeration or heating elements which can maintain a specific temperature within the receptacle 210, in order to preserve any items within the receptacle 210.

As shown in further detail in FIG. 5, the clamps 215 which engage the body 213 and the base portion 212 may be fixedly attached to the body 213 via a fixed section 216. The clamp may further include a hinged portion 217 that is capable of rotating in relation to the fixed portion 216, and engage a surface of the base portion 212. The hinged portion 217 may then be clamped down in relation to the fixed portion 216, to removably attach the base portion 212 and the body 213 together.

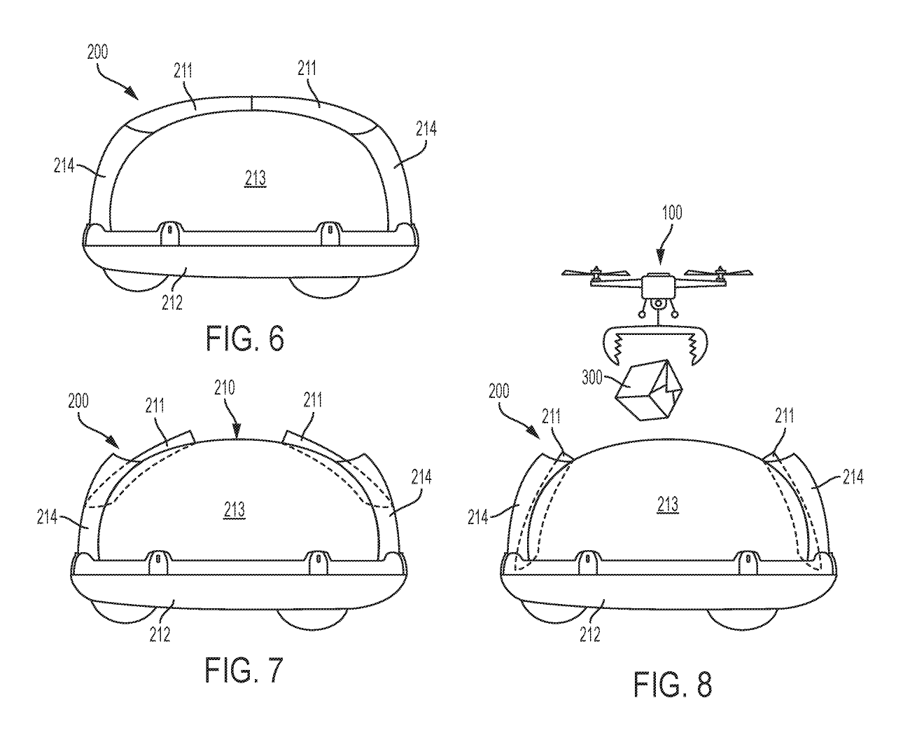

FIG. 6 depicts an embodiment of the AGV 200, wherein the retractable hood 211 comprises two portions which may move along two separate tracks 214. The retractable hood portions 211 may move in opposing directions along the separate tracks 214 to uncover a receptacle 210 located within the body 213 of the AGV 200, as shown in FIG. 7. In this manner, the opening to the receptacle 210 may be located at the top and center of the AGV 200, which allows for the UAV 100 to simply drop a package 300 within the receptacle 210, as shown in FIG. 8, or have the package 300 lowered into the receptacle 210.

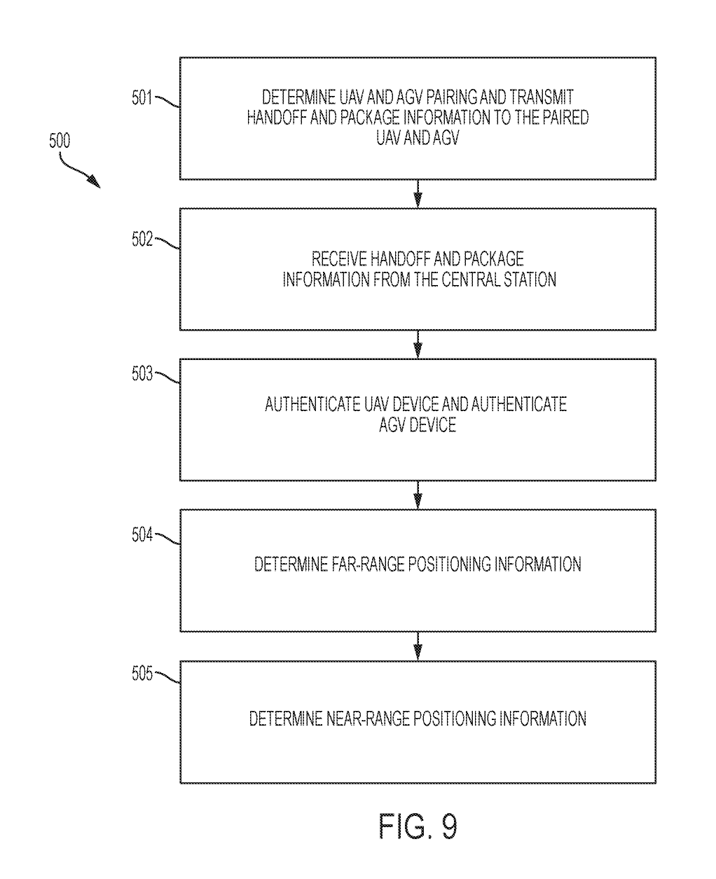

FIG. 9 shows an exemplary process 500 that the package delivery system may use to facilitate a handoff between an UAV 100 and AGV 200. At step 501, the central station 400 determines an UAV and AGV pairing and transmits handoff and package information to a paired UAV 100 and AGV 200. At step 502, the handoff and package information is received by the paired UAV 100 and AGV 200.

Once the paired UAV 100 and AGV 200 obtain the handoff and package information, the UAV 100 and AGV 200 each authenticate the other paired device at step 503. For example, UAV 100 may utilize computing device 103 to authenticate a handoff with AGV 200; similarly, AGV 200 may utilize computing device 203 to authenticate a handoff with UAV 100.

This authentication may be performed by any means, including the exchange of identification information, the use of private key encryption, or two-factor authentication. For example, the UAV 100 and AGV 200 may use blockchain authentication, which is an authentication scheme that utilizes a decentralized digital ledger to authenticate and record transactions in a “chain” of digital blocks. Other known means for authentication may be applied. The authentication stage ensures that the correct pairing of UAV 100 and AGV 200 interact with each other, and prevents third-party intervention with the handoff between an UAV 100 and AGV 200. When the UAV 100 and AGV 200 are authenticated, mission details for a package 300 may be exchanged.

At step 504, the UAV 100 and AGV 200 determine far-range positioning information, in order for a proper handoff to be executed. When the UAV 100 and AGV 200 are paired, they may be at great distances apart. At this step, the UAV 100 and AGV 200 may determine the best meeting location for the two devices, without the intervention of the central station 400. For instance, the UAV 100 and AGV 200 may take into account the speed, direction, and altitude of the other device, as well as mission information and route information, to determine an ideal meeting point. Further, the UAV 100 and AGV 200 may take into account information regarding whether an ideal meeting point is safe, including whether there are power lines, large trees, or other obstacles which may make a handoff difficult. The UAV 100 and AGV 200 may obtain safe meeting point information from the central station 400, or from internal computing devices 103 and 203. The AGV 200 may also navigate towards the meeting point and observe whether any such obstacles exists. Should a meeting place be considered unsafe, the AGV 200 may determine a different ideal meeting point.

At step 505, the UAV 100 and AGV 200 determine near-range positioning and alignment information for a proper handoff to be executed. When the UAV 100 and AGV 200 are in near-range (for instance, within 20 meters from each other), visual sensors and proximity sensors may be utilized to determine the proper positioning and alignment for a handoff. The UAV 100 utilizes visual sensors 120 and proximity sensors 121 to calculate positioning information of the UAV 100 in relation to the AGV 200 in realtime. Similarly, AGV 200 utilizes visual sensors 220 and proximity sensors 221 to calculate location information of the AGV 200 in relation to the UAV 100 in realtime. Proper positioning information may be determined based on speed, direction, and altitude of both the UAV 100 and AGV 200. Both devices may utilize this information, received mission information, as well as the determined information regarding the location of the AGV 200 in relation to the UAV 100 to determine the positioning information.

The UAV 100 and AGV 200 may also determine, based on mission information, or perceived information received from visual sensors 120/220 and proximity sensors 121/221 that the handoff is not viable. In such situations, the UAV 100 and/or AGV 200 may notify the central station 400 that a handoff is not viable. The central station 400 may then determine a new pairing.

In this manner, the UAV 100 and AGV 200 may assist each other in order to facilitate the exchange. At step 506, the UAV 100 may place the package 300 within the receptacle 211 of the AGV 200; or alternatively the UAV 100 may retrieve the package 300 from the receptacle 211 of the AGV 200. Once the handoff is complete, the UAV 100 and/or AGV 200 may transmit a handshake confirmation signal to the central station 400.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method for facilitating a package exchange between an AGV and UAV, comprising:
transmitting authentication information between the AGV and the UAV to authenticate the package exchange;
determining with the UAV viable exchange locations based on the mission and capabilities of the UAV;
determining with the AGV viable exchange locations based on the mission and capabilities of the AGV;
negotiating the exchange location between the UAV and the AGV based on the respective viable exchange locations;
determining a first set of positioning information, wherein the AGV utilizes mission information and information obtained from one or more sensors;
determining a second set of positioning information, wherein the UAV utilizes mission information and information obtained from one or more sensors;
transmitting the first set of positioning information from the AGV to the UAV;
transmitting the second set of positioning information from the UAV to the AGV;
aligning the UAV and the AGV with respect to each other to exchange the package based on the transmitted first and second sets of positioning information;
opening the AGV to allow access to a receptacle therein;
exchanging the package between the AGV and the UAV; and
closing the AGV to deny access to the receptacle.

2. The method of claim 1 further comprising determining, via a central station, a UAV and AGV pairing based on at least one of mission information, location information regarding the UAV and AGV, and operation information regarding the UAV and AGV.

3. The method of claim 1 further comprising determining whether exchanging the package is viable based on the mission information and the information obtained from one or more sensors.

4. The method of claim 3 further comprising transmitting a signal indicating that exchanging the package is not viable if exchanging the package is not viable.

5. The method of claim 3 further comprising determining the viable exchange location based on at least one of speed, direction, and altitude of the UAV and AGV.

6. The method of claim 1 wherein opening the AGV further comprises moving a retractable hood including two portions along two separate tracks to uncover the receptacle located in the AGV.

7. The method of claim 6 further comprising placing the package within the receptacle.

8. The method of claim 6 further comprising removing the package from the receptacle.

9. The method of claim 6, further comprising moving the retractable hood portions in opposing directions along the separate tracks.

10. The method of claim 1, wherein the step of authenticating the package exchange between the AGV and UAV further comprises utilizing public key authentication.

11. The method of claim 1, wherein the one or more sensors comprises at least one of a video camera, infrared camera, RADAR sensor, LIDAR sensor, or infrared sensor.

12. The method of claim 1, wherein the mission information comprises package destination package origination location, package weight, and special instructions for handling of the package.

13. A system for facilitating a package exchange between an AGV and UAV comprising:
a central station comprising at least one computer processor capable of determining a pairing between a UAV and a AGV;
wherein the UAV comprises at least one computer processor capable of determining a first set of positioning information based on mission information and information obtained from one or more sensors, transmission means for transmitting the first set of positioning information to the AGV, and a package grasping member capable of grasping and maneuvering the package;
wherein the AGV comprises at least one computer processor capable of determining a second set of positioning information based on mission information and information obtained from one of more sensors, transmission means for transmitting the second set of positioning information to the UAV, and a receptacle for storing the package.

14. The system of claim 13, wherein the UAV computer processor is capable of authenticating the package exchange between the AGV and the UAV.

15. The system of claim 13, wherein the AGV computer processor is capable of authenticating the package exchange between the AGV and the UAV.

16. The system of claim 13, wherein the mission information comprises package destination package origination location, package weight, and special instructions for handling of the package.

17. The system of claim 13, wherein the central station computer processor is further capable of determining a UAV and AGV pairing.

18. The system of claim 13, wherein at least one of the AGV computer processor and the UAV computer processor is capable of determining whether exchanging the package is viable based on the mission information and the information obtained from one or more sensors.

19. The system of claim 18, wherein at least one of the UAV transmitting means or the AGV transmitting means transmits a signal indicating that exchanging the package is not viable if exchanging the package is not viable.

20. A method for facilitating a package exchange between an AGV and UAV comprising:
determining, via a central station, a UAV and AGV pairing based on at least one of mission information, location information regarding the UAV and AGV, and operation information regarding the UAV and AGV;
authenticating the package exchange between the AGV and the UAV, without the AGV and the UAV each transmit authentication information to each other;
determining a meeting point location based on at least one of speed, direction, and altitude of the UAV and AGV;
determining a first set of positioning information, wherein the AGV utilizes mission information and information obtained from one or more sensors;
determining a second set of positioning information, wherein the UAV utilizes mission information and information obtained from one or more sensors;
transmitting the first set of positioning information from the AGV to the UAV;
transmitting the second set of positioning information from the UAV to the AGV;
determining whether exchanging the package is viable based on the mission information and the information obtained from one or more sensors;
transmitting a signal indicating that exchanging the package is not viable if exchanging the package is not viable;
one of placing the package within a receptacle in the AGV or removing the package form within a receptacle in the AGV;
transmitting a confirmation signal to the central station.
